(19) United States
(12) Patent Application Publication
(10) Pub. No.: US 2016/0125883 A1
(43) Pub. Date: May 5, 2016

(54) SPEECH RECOGNITION CLIENT APPARATUS PERFORMING LOCAL SPEECH RECOGNITION

(71) Applicant: ATR-TREK CO., LTD., Osaka-shi (JP)

(72) Inventor: Toshiaki KOYA, Osaka-shi (JP)

(73) Assignee: ATR-Trek Co., Ltd., Osaka-shi (JP)

(21) Appl. No.: 14/895,680

(22) PCT Filed: May 23, 2014
(86) PCT No.: PCT/JP2014/063683

§ 371 Date: Dec. 3, 2015

(30) Foreign Application Priority Data
Jun. 28, 2013 (JP) 2013-136306

(51) Int. Cl. G10L 15/30; G10L 15/22; G10L 15/08

(52) U.S. Cl. CPC G10L 15/30; G10L 15/08; G10L 15/22; G10L 2015/088

(57) ABSTRACT

[Object] An object is to provide a client having a local speech recognition function, capable of activating a speech recognition function of a speech recognition server in a natural manner, and capable of maintaining high precision while not increasing burden on a communication line.

[Solution] A speech recognition client apparatus 34 is a client that receives a result of speech recognition by a speech recognition server 36 through communication with the speech recognition server 36, and it includes: a framing unit 52 for converting a speech to audio data; a local speech recognition unit 80 performing speech recognition of the audio data; a transmission/reception unit 56 transmitting audio data to the speech recognition server and receiving a result of speech recognition by the speech recognition server; and a determining unit 82 and a communication control unit 86 for controlling transmission of audio data by the transmission/reception unit 56 in accordance with a result of recognition of the audio data by the speech recognition processing unit 80.

### TECHNICAL FIELD

The present invention relates to a speech recognition client apparatus having a function of recognizing speech through communication with a speech recognition server and, more specifically, to a speech recognition client apparatus having a local speech recognition function separate from the server.

### BACKGROUND ART

The number of portable terminals such as portable telephones connected to networks is exploding. A portable terminal is actually a small computer. Particularly, a so-called smartphone provides plentiful functions comparable to those of a desk-top computer, including site searches on the Internet, listening music and viewing videos, sending and receiving mails, bank transactions, sketches, and audio and video recording.

One bottleneck hindering use of these plentiful functions is the small size of the body of portable terminal. A portable telephone inherently has a small body. Therefore, a device allowing quick input such as a keyboard for a computer cannot be mounted thereon. Various methods of input using a touch-panel have been proposed, making input faster than before when compared. Input to the portable terminal, however, is still not very easy.

In these circumstances, speech recognition is attracting attention as means for input. The main stream of speech recognition today involves a statistic speech recognition apparatus that utilizes an acoustic model created by statistically processing a huge amount of speech data and a statistic language model obtained from a huge amount of documents. Such a speech recognition apparatus must have very high computational power. Therefore, conventionally, such an apparatus has been implemented only by a computer having large capacity and sufficiently high computational ability. When the speech recognition function is to be used on a portable terminal, a server, referred to as a speech recognition server, which provides the speech recognition function on-line is used, and the portable terminal operates as a speech recognition client using the results. For the speech recognition client to recognize speech, it transmits, on-line, speech data, coded data or speech features (feature values) obtained by locally processing speech to the speech recognition server, receives results of speech recognition, and executes a process accordingly. This approach has been taken because the portable terminal has relatively low computational ability and limited resources for computation.

Developments in semiconductor technology, however, immensely improved the computational ability of a CPU (Central Processing Unit) and increased memory capacity in several orders of magnitude than before. In addition, power consumption has been reduced. As a result, speech recognition becomes sufficiently feasible on a portable terminal. Further, since a portable terminal is used by a specific user, it is possible to specify in advance the speaker for the speech recognition and to prepare an acoustic model tailored for the speaker or to register specific vocabularies with a dictionary, so as to enhance precision of speech recognition.

Nevertheless, a speech recognition server is overwhelmingly superior in terms of available computational resources. Therefore, naturally, speech recognition by a speech recognition server has higher precision than that by a portable terminal

Japanese Patent Laying-Open No. 2010-85536 (hereinafter referred to as '536 Reference) proposes, notably in paragraphs [0045] to [0050] and FIG. 4, a solution that overcomes the weakness of relatively low precision of speech recognition implemented on a portable terminal. '536 Reference relates to a client that communicates with a speech recognition server. The client processes and converts speeches to audio data, transmits the audio data to the speech recognition server, and receives results of speech recognition from the speech recognition server. The results of speech recognition additionally have positions of bunsetsu, attributes of bunsetsu (character type), part of speech, temporal information of bunsetsu and so on. Using such information added to the results of speech recognition from the server, the client locally executes speech recognition. Here, since vocabularies or acoustic model registered locally are available, for some vocabularies, words erroneously recognized by the speech recognition server may possibly be recognized correctly.

According to '536 Reference, the client compares the results of speech recognition by the speech recognition server with the results of local speech recognition, and if there is any difference in the results of recognition, the user selects either one.

### SUMMARY OF INVENTION

### Technical Problem

The client disclosed in '536 Reference attains superior effects that the results of recognition by the speech recognition server can be complemented by the results of local speech recognition. Considering the method of use of speech recognition on a portable terminal at present, however, there is still room for improvement regarding the operation of portable terminal having such a function. One problem is how to cause the portable terminal to start the speech recognition process.

'536 Reference does not disclose how to locally start speech recognition. Currently available portable terminals dominantly use a button displayed on a screen to start speech recognition, and when the button is touched, the speech recognition function is activated. Some others use a hardware button dedicated to start speech recognition. There is also an application running on a portable phone not having the local speech recognition function that starts speech input and transmission of audio data when it is detected by a sensor that the user assumes a posture of utterance, that is, when the user holds the phone to his ear.

All these approaches, however, require the user to do a specific operation to activate the speech recognition function. It is expected that the speech recognition function will be used more frequently to use various and many functions on portable terminals in the future and, therefore, it is necessary to activate the speech recognition function in a more natural manner On the other hand, amount of communication between the portable terminal and the speech recognition server must be as small as possible, and the precision of speech recognition must be kept high.

Therefore, an object of the present invention is to provide a speech recognition client apparatus using a speech recognition server and having a local speech recognition function, which allows activation of the speech recognition function in a natural manner and maintains precision of speech recognition while not increasing load on a communication line.

### Solution To Problem

According to a first aspect, the present invention provides a speech recognition client apparatus receiving, through a communication with a speech recognition server, a result of speech recognition by the speech recognition server. The speech recognition client apparatus includes: speech converting means for converting a speech to audio data; speech recognizing means for performing speech recognition on the audio data; transmission/reception means for transmitting the audio data to the speech recognition server and receiving a result of speech recognition by the speech recognition server; and transmission/reception control means for controlling transmission of audio data by the transmission/reception means in accordance with a result of recognition of the audio data by the speech recognizing means.

Based on the output of local speech recognizing means, whether or not the audio data is to be transmitted to the speech recognition server is determined No special operation other than an utterance is necessary to use the speech recognition server. If the result of recognition by the speech recognizing means is not a specific one, transmission of audio data to the speech recognition server does not take place.

As a result, by the present invention, a speech recognition client apparatus that allows activation of the speech recognition function in a natural manner and maintains precision of speech recognition while not increasing load on a communication line can be provided.

Preferably, the transmission/reception control means includes: keyword detecting means for detecting existence of a keyword in a result of speech recognition by the speech recognizing means and for outputting a detection signal; and transmission start control means, responsive to the detection signal, for controlling the transmission/reception means such that, of the audio data, a portion having a prescribed relation with a start of an utterance segment of the keyword is transmitted to the speech recognition server.

If a keyword is detected in the result of speech recognition by the local speech recognizing means, transmission of audio data starts. What is necessary to use the speech recognition by the speech recognition server is simply an utterance of a special keyword, and no explicit operation such as pressing a button is required to start speech recognition.

More preferably, the transmission start control means includes means responsive to the detection signal for controlling the transmission/reception means such that, of the audio data, a portion starting from an utterance end position of the keyword is transmitted to the speech recognition server.

Since the audio data starting from the portion following the keyword is transmitted to the speech recognition server, it becomes unnecessary to carry out speech recognition of the keyword portion on the speech recognition server. Since no keyword is included in the result of speech recognition, the result of speech recognition related to the contents uttered following the keyword can directly be used.

More preferably, the transmission start control means includes means responsive to the detection signal for controlling the transmission/reception means such that, of the audio data, a portion starting from an utterance start position of the keyword is transmitted.

Since transmission to the speech recognition server starts from the start position of keyword utterance, it is possible to confirm the keyword portion on the side of the speech recognition server, or to verify the correctness of local speech recognition by the portable terminal using the result of speech recognition on the speech recognition server.

The speech recognition client apparatus further includes: match determining means for determining whether or not a start portion of a result of speech recognition by the speech recognition server received by the transmission/reception means matches the keyword detected by the keyword detection means; and means for selectively executing a process of using the result of speech recognition by the speech recognition server received by the transmission/reception means or a process of discarding the result of speech recognition by the speech recognition server, depending on a result of determination by the match determining means.

If the result of local speech recognition differs from the result of speech recognition by the speech recognition server, whether or not the utterance by the speaker is to be processed is determined using the result of speech recognition server, which is believed to have higher precision,. If the result of local speech recognition is erroneous, the speech recognition result by the speech recognition server is not at all used, and the portable terminal continues operation as if nothing has happened. Therefore, it is possible to prevent the speech recognition client apparatus from executing any process unintended by the user that could otherwise be caused by an error in the result of local speech recognition.

Preferably, the transmission/reception control means includes: keyword detecting means for detecting existence of a first keyword or existence of a second keyword in a result of speech recognition by the speech recognizing means and for outputting a first detection signal or a second detection signal, respectively. The second keyword represents a request for a certain process. The transmission/reception control means further includes transmission start control means, responsive to the first detection signal, for controlling the transmission/reception means such that a portion of the audio data having a prescribed relation with a start of an utterance segment of the first keyword is transmitted to the speech recognition server; and transmission end control means, responsive to generation of the second detection signal after transmission of the audio signal is started by the transmission/reception means, for ending transmission of audio data by the transmission/reception means at an end position of utterance of the second keyword in the audio data.

When the audio data is to be transmitted to the speech recognition server, if the first keyword is detected in the result of speech recognition by the local speech recognizing means, the audio data of that portion which has a prescribed relation with the start position of utterance of the first keyword is transmitted to the speech recognition server. Thereafter, if the second keyword requesting some process is detected in the result of speech recognition by the local speech recognizing means, transmission of audio data thereafter is stopped. When the speech recognition server is to be used, what is necessary is simply to utter the first keyword, and by uttering the second keyword, transmission of audio data can be stopped at that time point. Therefore, it is unnecessary to detect a prescribed mute period to detect the end of utterance, and response to speech recognition can be improved.

### BRIEF DESCRIPTION OF DRAWINGS

FIG. 1 is a block diagram showing a schematic configuration of the speech recognition system in accordance with a first embodiment of the present invention.

FIG. 2 is a functional block diagram of a portable telephone as a portable terminal in accordance with the first embodiment.

FIG. 3 is a schematic diagram illustrating the manner of output of sequential speech recognition.

FIG. 4 is a schematic illustration showing start and end timings of transmission of audio data to the speech recognition server and the contents of transmission, in accordance with the first embodiment.

FIG. 5 is a flowchart representing a control structure of a program controlling start and end of transmission of audio data to the speech recognition server in accordance with the first embodiment.

FIG. 6 is a flowchart representing a control structure of a program controlling a portable terminal using the result by the speech recognition server and the result of local speech recognition, in accordance with the first embodiment.

FIG. 7 is a functional block diagram of a portable telephone as a portable terminal in accordance with a second embodiment of the present invention.

FIG. 8 is a schematic illustration showing start and end timings of transmission of audio data to the speech recognition server and the contents of transmission, in accordance with the second embodiment.

FIG. 9 is a flowchart representing a control structure of a program controlling start and end of transmission of audio data to the speech recognition server in accordance with the second embodiment.

FIG. 10 is a hardware block diagram showing a configuration of the apparatus in accordance with the first and second embodiments.

### DESCRIPTION OF EMBODIMENTS

In the following description and in the drawings, the same components are denoted by the same reference characters. Therefore, detailed description thereof will not be repeated.

### First Embodiment

[Outline]

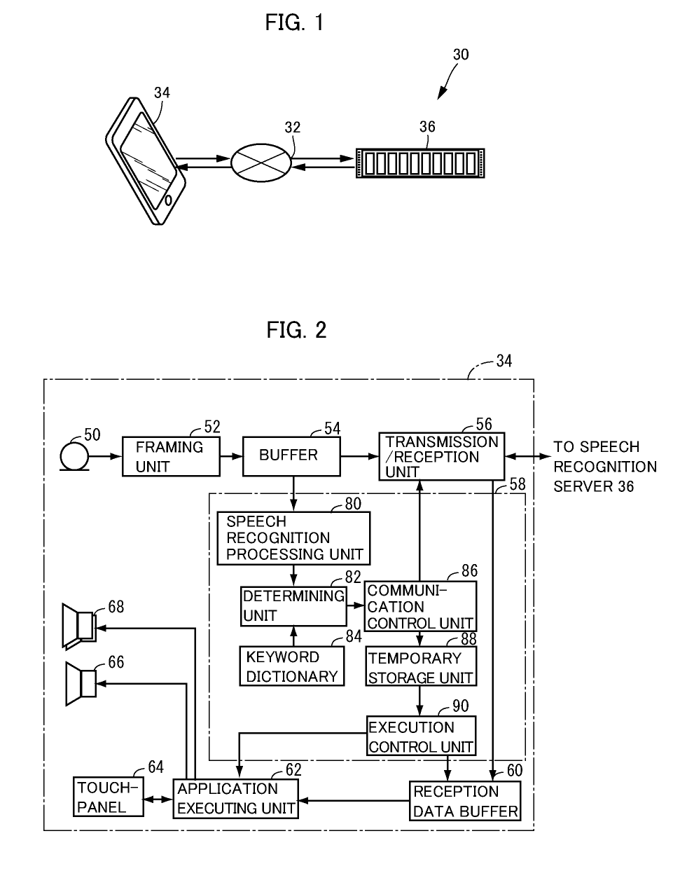

Referring to FIG. 1, a speech recognition system 30 in accordance with a first embodiment includes a portable telephone 34 as a speech recognition client apparatus having a local speech recognition function, and a speech recognition server 36. These are communicable with each other through the Internet 32. In the present embodiment, portable telephone 34 has a function of local speech recognition, and realizes response to a user operation in a natural manner while not increasing the amount of communication with speech recognition server 36. In the following embodiment, the audio data transmitted from portable telephone 34 to speech recognition server 36 is data obtained by framing audio signals, whereas it may be coded data obtained by encoding audio signals, or features used in speech recognition process that takes place in speech recognition server 36.

[Configuration]

Referring to FIG. 2, portable telephone 34 includes: a microphone 50; a framing unit 52 digitizing audio signals output from microphone 50 and framing the same with a prescribed frame length and a prescribed shift length; a buffer 54 temporarily storing audio data as outputs from framing unit 52; and a transmission/reception unit 56 performing a process of transmitting the audio data accumulated in buffer 54 to speech recognition server 36 and a process of receiving data from a network including result of speech recognition from speech recognition server 36 by wireless communication. Each frame output from framing unit 52 has appended thereto temporal information of each frame.

Portable telephone 34 further includes: a control unit 58 for performing a background process of executing local speech recognition on the audio data accumulated in buffer 54 and in response to detection of a prescribed keyword in the result of speech recognition, for controlling start and end of transmission of audio signals by transmission/reception unit 56 to speech recognition server 36, and performing a process of comparing the result received from the speech recognition server and the result of local speech recognition and controlling an operation of portable telephone 34 in accordance with the comparison result; a reception data buffer 60 for temporarily accumulating results of speech recognition received by transmission/reception unit 56 from speech recognition server 36; an application executing unit 62 responsive to generation of an execution instructing signal by control unit 58 based on the comparison between the local speech recognition result and the speech recognition result from speech recognition server 36, for executing an application using contents in reception data buffer 60; a touch-panel 64 connected to application executing unit 62; a speaker 66 for receiving a call connected to application executing unit 62; and a stereo speaker 68 also connected to application executing unit 62.

Control unit 58 includes: a speech recognition processing unit 80 for executing the local speech recognition process on the audio data accumulated in buffer 54; a determining unit 82 determining whether or not a prescribed keyword (a start keyword and an end keyword) for controlling transmission/reception of audio data to/from speech recognition server 36 is included in the result of speech recognition output from speech recognition processing unit 80, and if it is included, outputting a detection signal together with the keyword; and a keyword dictionary 84 storing one or a plurality of start keywords as the objects of determination by determining unit 82. When a mute period lasts for a prescribed threshold or longer, speech recognition processing unit 80 deems the utterance to be terminated, and outputs an end-of-utterance detection signal. Receiving the end-of-utterance detection signal, determining unit 82 issues an instruction towards communication control unit 86 to end transmission of data to speech recognition server 36.

As the start keyword stored in keyword dictionary 84, a noun is used in order to distinguish as much as possible from ordinary utterances. Considering that a request for some process is made on portable telephone 34, this noun may be a proper noun as it is natural and preferable. In place of a proper noun, a specific command term may be used.

As the end keyword, in Japanese, different from the start keyword, a more ordinary Japanese expression is adopted for asking someone to do something, such as an imperative form of a verb, a basic form+end form of a verb, a request expression, or an interrogative expression. Specifically, if any of these is detected, it is determined that an end keyword is detected. This approach allows the user to ask the portable telephone to execute a process in a natural manner of speaking. In order to realize such a process, speech recognition processing unit 80 should be able to add pieces of information such as parts of speech, inflection of verbs, and types of particles to each word of the result of speech recognition.

Control unit 58 further includes: a communication control unit 86, responsive to reception of a detection signal and a detected keyword from determining unit 82, for starting or ending a process of transmitting audio data accumulated in buffer 54 to speech recognition server 36 depending on whether the detected keyword is a start keyword or an end keyword; a temporary storage unit 88 for storing a start keyword among the keywords detected by determining unit 82 in the result of speech recognition by speech recognition processing unit 80; and an execution control unit 90, comparing a start portion of a text as a result of speech recognition by speech recognition server 36 received by reception data buffer 60 with a start keyword as a result of local speech recognition stored in temporary storage unit 88, and if these match with each other, controlling application executing unit 62 such that a prescribed application is executed using that part of the data stored in reception data buffer 60 which follows the start keyword. In the present embodiment, what application is to be executed is determined by application executing unit 62 based on the contents stored in reception data buffer 60.

Speech recognition processing unit 80 executes speech recognition of audio data accumulated in buffer 54 and outputs the result of speech recognition in either one of two methods: utterance-by-utterance method and sequential method. In the utterance-by-utterance method, if there is a silent segment exceeding a prescribed time period in the audio data, the result of speech recognition by that time point are output, and speech recognition is newly started from the next segment of utterance. In the sequential method, results of speech recognition of entire audio data stored upon reception in buffer 54 are output at every prescribed time interval (for example, at every 100 milliseconds). Therefore, if the utterance segment becomes longer, the texts representing the result of speech recognition become longer accordingly. In the present embodiment, speech recognition processing unit 80 adopts the sequential method. If the utterance segment becomes very long, speech recognition by speech recognition processing unit 80 becomes difficult. Therefore, when the utterance segment reaches a prescribed time period or longer, speech recognition processing unit 80 regards that the utterance ended and force-terminates the speech recognition by that time point and starts speech recognition anew. It is noted that the following functions can be realized in the similar manner as in the present embodiment if speech recognition processing unit 80 adopts the utterance-by-utterance method.

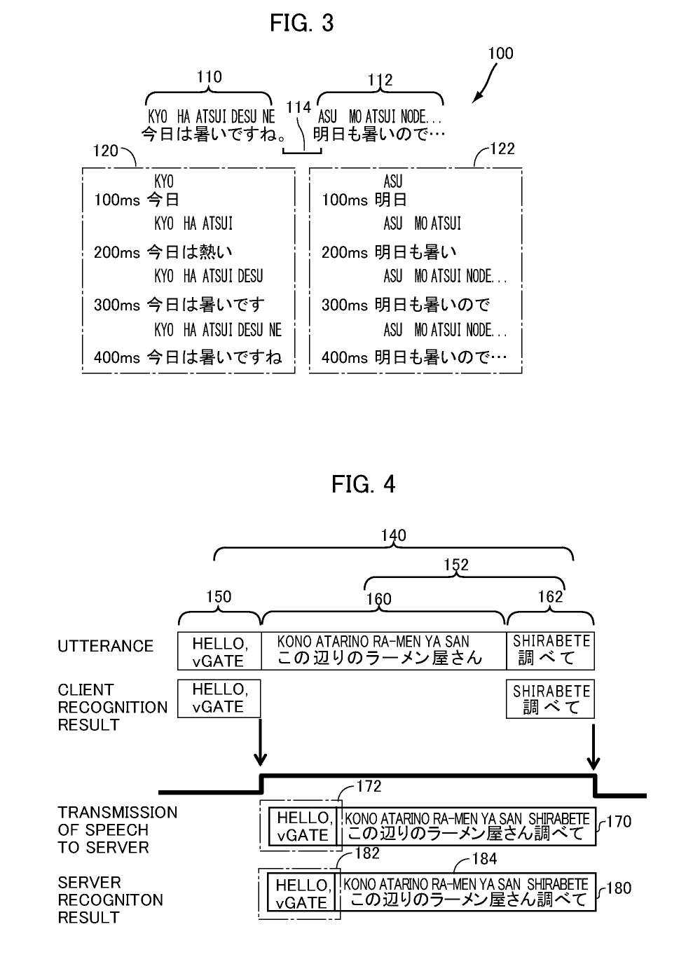

Referring to FIG. 3, output timing of speech recognition processing unit 80 will be described. Assume that an utterance 100 includes a first utterance 110 and a second utterance 112, and that a silent segment 114 exists between these two utterances. While audio data is being accumulated in buffer 54, speech recognition processing unit 80 outputs the result of speech recognition of the entire speeches accumulated in buffer 54 at every 100 milliseconds, as represented by speech recognition result 120. In this method, part of the speech recognition result may be modified. By way of example, in the speech recognition result 120 shown in FIG. 3, the word “ATSUI” [symbol] output at the time point of 200 milliseconds is modified to “ATSUI” [symbol] . In this method, if the duration of silent segment 114 exceeds a prescribed threshold, the utterance is deemed to be terminated. As a result, the audio data that has been accumulated in buffer 54 is cleared (disposed) and a speech recognition process for the next utterance starts. In the example of FIG. 3, the next result of speech recognition 122 are output together with new time information, from speech recognition processing unit 80. For each of the speech recognition results 120 and 122, determining unit 82 determines, every time the result of speech recognition is output, whether it matches any of the start keywords stored in keyword dictionary 84 or it satisfies the condition of an end keyword, and outputs a start keyword detection signal or an end keyword detection signal. It is noted, however, that in the present embodiment, the start keyword is detected only when no audio data is being transmitted to speech recognition server 36, and that the end keyword is detected only when a start keyword has been detected.

[Operation]

Portable telephone 34 operates in the following manner. Microphone 50 constantly detects speeches therearound and applies audio signals to framing unit 52. Framing unit 52 digitizes and frames audio signals and successively inputs the resulting data to buffer 54. Speech recognition processing unit 80 performs speech recognition at every 100 milliseconds on the entire audio data that is being accumulated in buffer 54, and outputs a result to determining unit 82. Local speech recognition processing unit 80 clears buffer 54 when it detects a silent segment equal to or longer than a threshold time period, and outputs a signal (end-of-utterance detection signal) indicating detection of an end of utterance to determining unit 82.

Receiving the result of local speech recognition from speech recognition processing unit 80, determining unit 82 determines whether the received result contains a start keyword stored in keyword dictionary 84, or any expression satisfying a condition of an end keyword. If a start keyword is detected in the result of local speech recognition while no audio data is being transmitted to speech recognition server 36, determining unit applies a start keyword detection signal to communication control unit 86. On the other hand, if an end keyword is detected in the result of local speech recognition while audio data is being transmitted to speech recognition server 36, determining unit 82 applies an end keyword detection signal to communication control unit 86. Further, when an end-of-utterance detection signal is received from speech recognition processing unit 80, determining unit 82 instructs communication processing unit 86 to end transmission of audio data to speech recognition server 36.

When a start keyword detection signal is applied from determining unit 82, communication control unit 86 causes transmission/reception unit 56 to read, among the data stored in buffer 54, data from the start position of the detected start keyword and to transmit the read data to speech recognition server 36. At this time, communication control unit 86 stores the start keyword applied from determining unit 82 in temporary storage unit 88. When an end keyword detection signal is applied from determining unit 82, communication control unit 86 causes transmission/reception unit 56 to transmit, among the data stored in buffer 54, audio data up to the detected end keyword to speech recognition server 36 and then to end transmission. When an instruction to end transmission by the end-of-utterance detection signal is applied from determining unit 82, communication control unit 86 causes transmission/reception unit 56 to transmits, among the audio data stored in buffer 54, all the audio data up to the time point when end-of-utterance was detected to speech recognition server 36 and then to end the transmission.

After communication control unit 86 starts transmission of audio data to speech recognition server 36, reception data buffer 60 accumulates data of speech recognition results transmitted from speech recognition server 36. Execution control unit 90 determines whether the start portion of reception data buffer 60 matches the start keyword stored in temporary storage unit 88. If these two match, execution control unit 90 controls application executing unit 62 such that from reception data buffer 60, data following the portion that match the start keyword is read. Based on the data read from reception data buffer 60, application executing unit 62 determines what application is to be executed, and passes the result of speech recognition to the determined application to process it. The result of processing is given, for example, as a display on a touch-panel 64, or as audio output from a speaker 66 or a stereo speaker 68.

A specific example will be described with reference to FIG. 4. Assume that a user made an utterance 140. The utterance 140 includes an utterance portion 150 of “Hello vGate” and an utterance portion 152 of “KONOATARINO RA-MENYASAN SHIRABETE (Please find a Ramen restaurant in the neighborhood).” Utterance portion 152 includes an utterance portion 160 of “KONOATARINO RA-MENYASAN (a Ramen restaurant in the neighborhood)” and an utterance portion 162 of “SHIRABETE (please find).”

Here, it is assumed that “Hello vGate”, “Mr. Sheep” and the like are registered as the start keywords. As the utterance portion 150 matches the start keyword, the process of transmitting audio data 170 to speech recognition server 36 starts at the time point when speech recognition of utterance portion 150 is done. Audio data 170 includes the entire audio data of utterance 140 as shown in FIG. 4, and its start portion is the audio data 172 corresponding to the start keyword.

On the other hand, of the utterance portion 162, the expression “SHIRABETE (please find)” is an expression of request, and it satisfies the condition as an end keyword. Therefore, the process of transmitting audio data 170 to speech recognition server 36 ends at the time point when this expression is detected in the result of local speech recognition.

When transmission of audio data 170 ends, a speech recognition result 180 of audio data 170 is transmitted from speech recognition server 36 to portable telephone 34 and stored in reception data buffer 60. The start portion 182 of speech recognition result 180 represents the result of speech recognition of audio data 172 corresponding to the start keyword. If the start portion 182 matches the result of speech recognition by the client of utterance portion 150 (start keyword), speech recognition result 184 of the portion following the start portion 182 out of the result of speech recognition, is transmitted to application executing unit 62 (see FIG. 1), and processed by an appropriate application. If the start portion 182 does not match the result of speech recognition by the client of utterance portion 150 (start keyword), reception data buffer 60 is cleared and application executing unit 62 does not operate at all.

As described above, according to the present embodiment, when local speech recognition detects a start keyword in an utterance, the process of transmitting audio data to speech recognition server 36 starts. When local speech recognition detects an end keyword is detected in the utterance, transmission of audio data to speech recognition server 36 ends. The start portion of the result of speech recognition transmitted from speech recognition server 36 is compared with the start keyword detected by the local speech recognition, and if these match, certain process is executed using the result of speech recognition by speech recognition server 36. Therefore, according to the present embodiment, if the user wishes to have his/her portable telephone 34 execute some process, what is necessary for the user is to utter the start keyword and the contents to be executed and nothing more. If the local speech recognition correctly recognizes the start keyword, a desired process using the result of speech recognition by portable telephone 34 is executed and the result is output by portable telephone 34. It is unnecessary, for example, to press a button to start speech input and, therefore, it becomes easier to use portable telephone 34.

In such a process, a problem arises when the start keyword is detected erroneously. As described above, generally, speech recognition locally done by a portable terminal is less precise than speech recognition executed by a speech recognition server. Therefore, it is possible that a start keyword is erroneously detected by the local speech recognition. In such a case, if some process is done based on the erroneously detected start keyword and the result is output by portable telephone 34, it would be an unintended operation for the user. Such an operation is undesirable.

In the present embodiment, even when the local speech recognition erroneously detects a start keyword, no process is done by portable telephone 34 unless the start portion of the speech recognition result by speech recognition server 36 matches the start keyword. The state of portable telephone 34 does not change and hence it appears to be doing nothing. Therefore, the user does not at all notice if any process as described above has taken place.

Further, in the above-described embodiment, when a start keyword is detected by the local speech recognition, the process of transmitting audio data to speech recognition server 36 starts, and when an end keyword is detected by the local speech recognition, the transmission process ends. It is unnecessary for the user to do any special operation to end transmission of speech. As compared with a method of terminating transmission if silence of a prescribed time period or longer is detected, transmission of audio data to speech recognition server 36 can be stopped immediately after the end keyword is detected. As a result, wasteful data transmission from portable telephone 34 to speech recognition server 36 can be prevented, and response of speech recognition can be improved.

[Program Implementation]

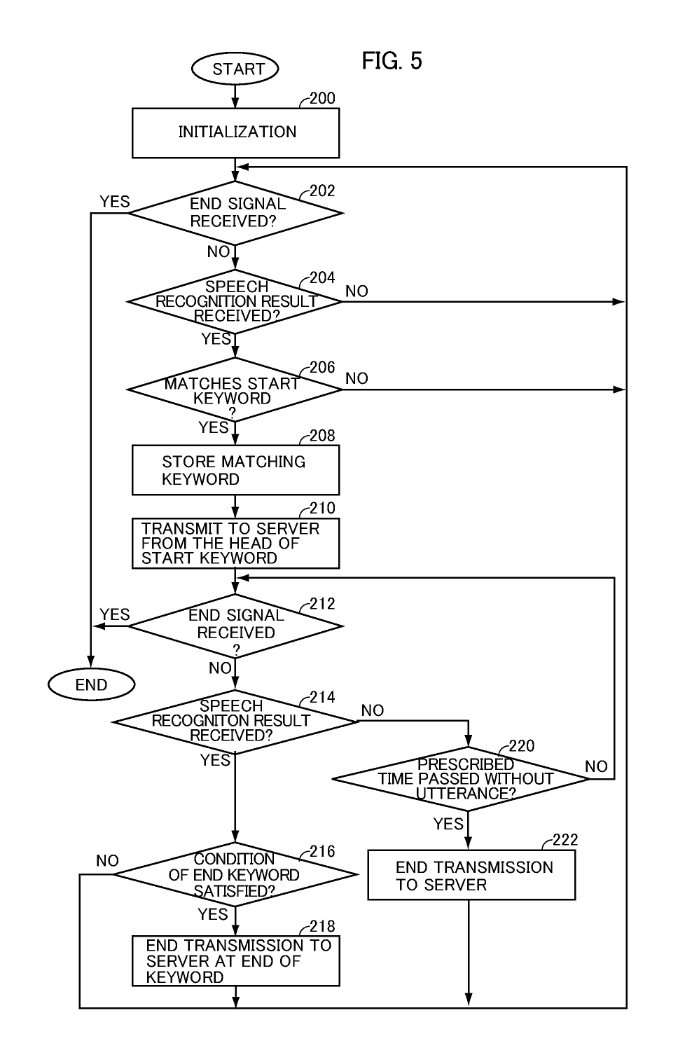

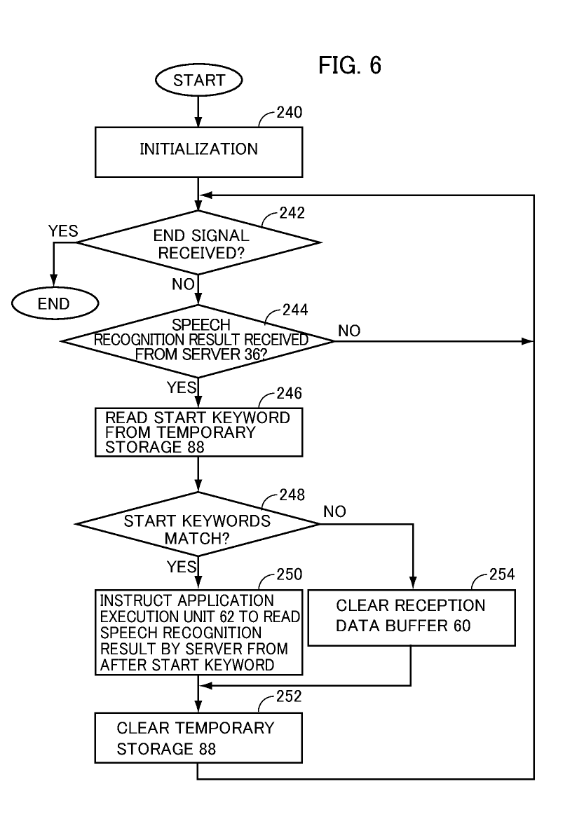

Portable telephone 34 in accordance with the first embodiment described above can be realized by a portable telephone hardware similar to a computer, as will be described later, and a program executed by a processor mounted thereon. FIG. 5 shows, in the form of a flowchart, a control structure of a program realizing the functions of determining unit 82 and communication control unit 86 shown in FIG. 1, and FIG. 6 shows, in the form of a flowchart, a control structure of a program realizing the function of execution control unit 90. Though these two are described as separate programs here, these can be integrated to one, or each of these can be divided to programs of smaller units.

Referring to FIG. 5, the program realizing the functions of determining unit 82 and communication control unit 86 includes: a step 200, activated when portable telephone 34 is powered-on, of executing initialization of a memory area to be used, for example; a step 202 of determining whether or not an end signal instructing ending of program execution is received from the system and, if the end signal is received, executing a necessary ending process and ending execution of the program; and a step 204, executed if the end signal is not received, of determining whether or not a result of local speech recognition is received, and if not, returning the control to step 202. As already described, speech recognition processing unit 80 sequentially outputs the result of speech recognition at every prescribed time period. Therefore, the determination at step 204 becomes YES at every prescribed time period.

The program further includes: a step 206, executed in response to a determination at step 204 that the result of local speech recognition has been received, of determining whether or not any of start keywords stored in keyword dictionary 84 is included in the result of local speech recognition, and if not, returning the control to step 202; a step 208 of storing, if any of the start keywords is found in the result of local speech recognition, the start keyword in temporary storage unit 88; and a step 210 of instructing transmission/reception unit 56 to start transmission of audio data stored in buffer 54 (FIG. 2) to speech recognition server 36, starting from the start portion of the start keyword. Thereafter, the flow proceeds to the process that takes place during audio data transmission to portable telephone 34.

The process during audio data transmission includes: a step 212 of determining whether or not an end signal of the system is received, and if received, performing a necessary process and thereby to end execution of the program; a step 214, executed if the end signal is not received, of determining whether or not a result of local speech recognition is received from speech recognition processing unit 80; a step 216, executed if the result of local speech recognition is received, of determining whether or not an expression satisfying the end keyword condition is found therein, and if not, returning the control to step 202; and a step 218, executed if an expression satisfying the condition of end keyword is found in the result of local speech recognition, of transmitting that portion of audio data stored in buffer 54 which is up to the tail of the portion where the end keyword is detected, to speech recognition server 36, ending the transmission, and returning control to step 202.

The program further includes: a step 220, executed if it is determined at step 214 that the result of local speech recognition is not received from speech recognition processing unit 80, of determining whether or not a prescribed time period has passed without any utterance and if the prescribed time period has not yet passed, returning control to step 212; and a step 222 of ending, if the prescribed time period has passed without any utterance, the transmission of audio data stored in buffer 54 to speech recognition server 36, and returning control to step 202.

Referring to FIG. 6, the program realizing execution control unit 90 of FIG. 2 includes: a step 240, activated when portable telephone 34 is powered on, of executing necessary initialization process; a step 242 of determining whether or not an end signal is received, and ending execution of the program if it is received; and a step 244 of determining, if the end signal is not received, whether or not data of the result of speech recognition is received from speech recognition server 36, and if not received, returning control to step 242.

The program further includes: a step 246 of reading, when the data of the result of speech recognition is received from speech recognition server 36, the start keyword stored in temporary storage unit 88; a step 248 of determining whether or not the start keyword read at step 246 matches the start portion of the data of the result of speech recognition from speech recognition server 36; a step 250, executed if these match, of controlling application executing unit 62 such that of the result of speech recognition by speech recognition server 36, the data from a position following the end of the start keyword to the end is read from reception data buffer 60; a step 254, executed if it is determined at step 248 that the start keyword does not match, of clearing (or disposing) the result of speech recognition by speech recognition server 36 stored in reception data buffer 60; and a step 252, executed after step 250 or 254, of clearing temporary storage unit 88 and returning control to step 242.

According to the program shown in FIG. 5, if it is determined at step 206 that the result of local speech recognition matches the start keyword, the start keyword is stored in temporary storage unit 88 at step 208, and from step 210, of the audio data stored in buffer 54, the audio data from the start portion that matches the start keyword is transmitted to speech recognition server 36. If an expression satisfying the condition of an end keyword is detected in the result of local speech recognition while the audio data is being transmitted (YES at step 216 of FIG. 5), of the audio data stored in buffer 54, the data up to the end portion of end keyword is transmitted to speech recognition server 36, and the transmission ends.

On the other hand, if the determination at step 248 of FIG. 6 is positive when the result of speech recognition is received from speech recognition server 36, of the result of speech recognition, the portion following the portion that matches the start keyword is read from reception data buffer 60 to application executing unit 62, and application executing unit 62 executes an appropriate process in accordance with the contents of the result of speech recognition.

Therefore, by executing the programs having the control structures shown in FIGS. 5 and 6 on portable telephone 34, the functions of the embodiment above can be realized.

### Second Embodiment

In the embodiment described above, when a start keyword is detected by the local speech recognition, the start keyword is temporarily stored in temporary storage unit 88. When the result of speech recognition is returned from speech recognition server 36, depending on whether the start position of the result of speech recognition matches the temporarily stored start keyword, whether or not the process using the result of speech recognition by speech recognition server 36 is to be done is determined

The present invention, however, is not limited to such an embodiment. An embodiment in which the result of speech recognition by speech recognition server 36 is directly used without such a determination is also possible. This is effective particularly when the keyword can be detected with high precision by local speech recognition.

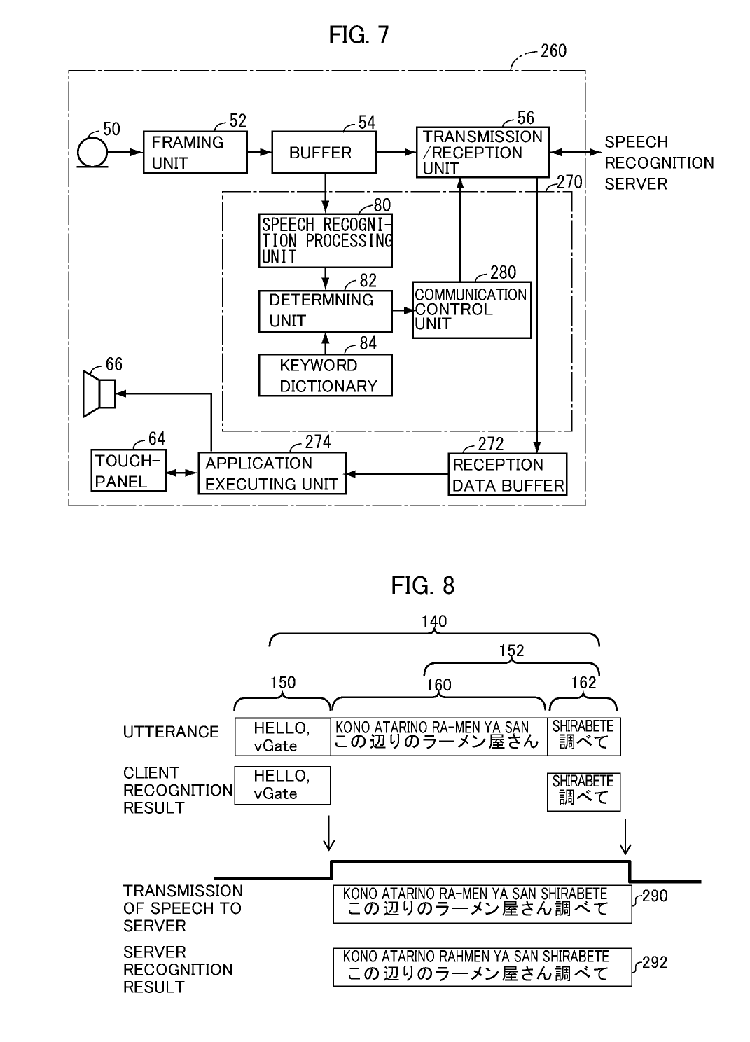

Referring to FIG. 7, a portable telephone 260 in accordance with the second embodiment has basically the same configuration as portable telephone 34 in accordance with the first embodiment. It is different, however, in that it does not include a functional block necessary for comparing the result of speech recognition by speech recognition server 36 and the start keyword, and hence, it is simpler.

Specifically, portable telephone 260 is different from portable telephone 34 of the first embodiment in the following points: it has, in place of control unit 58, a control unit 270 as a simplified version of control unit 58 shown in FIG. 1, simplified not to perform the comparison between the result of speech recognition by speech recognition server 36 with the start keyword; it has, in place of reception data buffer 60 shown in FIG. 1, a reception data buffer 272 temporarily holding the results of speech recognition from speech recognition server 36 and outputting all, independent of the control by control unit 58; and it has, in place of application executing unit 62 shown in FIG. 1, an application executing unit 274 of processing all the results of speech recognition from speech recognition server 36, independent of the control of control unit 270.

Control unit 270 is different from control unit 58 of FIG. 1 in that it does not have temporary storage unit 88 and execution control unit 90 shown in FIG. 1, and that in place of communication control unit 86, it has a communication control unit 280 having a function of controlling transmission/reception unit 56 such that when a start keyword is detected in the result of local speech recognition, the process of transmitting, of the audio data stored in buffer 54, data immediately after the position corresponding to the start keyword to speech recognition server 36 is started. As is the case with control unit 58, communication control unit 280 also controls transmission/reception unit 56 such that transmission of audio data to speech recognition server 36 is stopped, when an end keyword is detected in the result of local speech recognition.

Referring to FIG. 8, an operation of portable telephone 260 in accordance with the present embodiment will be outlined. It is assumed that the utterance 140 has the same configuration as that shown in FIG. 4. When a start keyword is detected in utterance portion 150 of utterance 140, control unit 270 in accordance with the present embodiment transmits, of the audio data, audio data 290 following the portion where the start keyword is detected up to immediately after detection of an end keyword (corresponding to utterance portion 152 shown in FIG. 8), to speech recognition server 36. Specifically, audio data 290 does not include the audio data of the start keyword portion. As a result, the start keyword is not included in a result of speech recognition 292 returned from speech recognition server 36. Therefore, if the result of local speech recognition of utterance portion 150 is correct, the start keyword is not included in the speech from the server either, and there will be no problem when the result of speech recognition 292 is processed in its entirety by application executing unit 274.

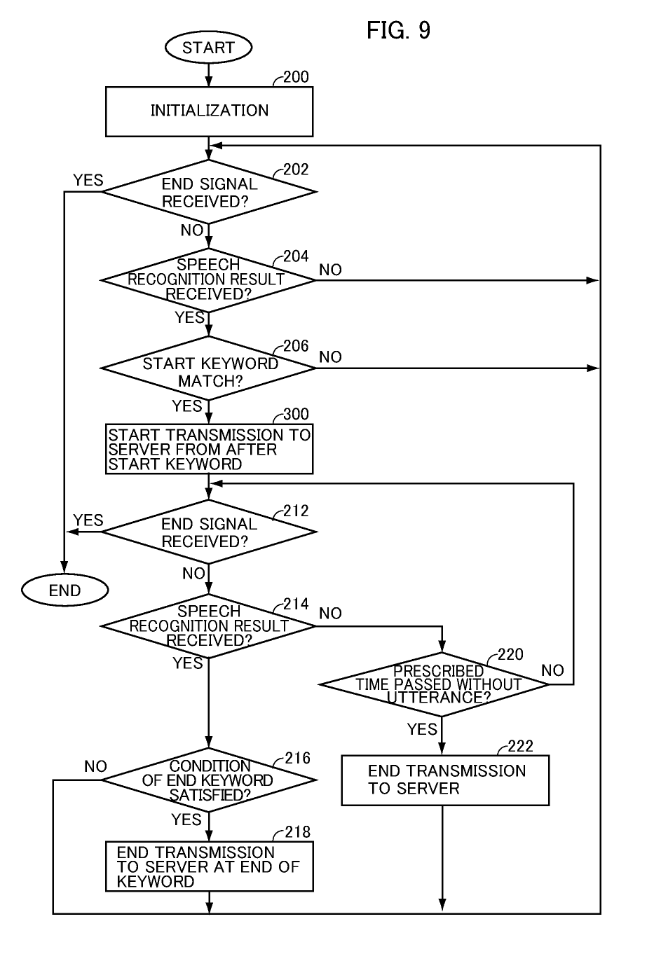

FIG. 9 shows, in the form of a flowchart, a control structure of a program for realizing the functions of determining unit 82 and communication control unit 280 of portable telephone 260 in accordance with the present embodiment. This figure corresponds to FIG. 5 of the first embodiment. In the present embodiment, the program having the control structure shown in FIG. 6 of the first embodiment is unnecessary.

Referring to FIG. 9, the program does not include the step 208 of the control structure of FIG. 5, and it includes, in place of step 210, a step 300 of controlling transmission/reception unit 56 such that, of the audio data stored in buffer 54, audio data from a position following the end of start keyword is transmitted to speech recognition server 36. Except for this point, the program has the same control structure as that shown in FIG. 5. The operation of control unit 270 when the program is executed is also sufficiently clear from the description above.

In the second embodiment, the same effects as the first embodiment can be attained in that the user does not need any special operation to start transmission of audio data and that the amount of data can be reduced when the audio data is transmitted to speech recognition server 36. Further, the second embodiment attains the effect that, if the local speech recognition has high precision in detecting a keyword, various processes using the results of speech recognition by the server are available through simple control.

[Hardware Block Diagram of Portable Telephone]

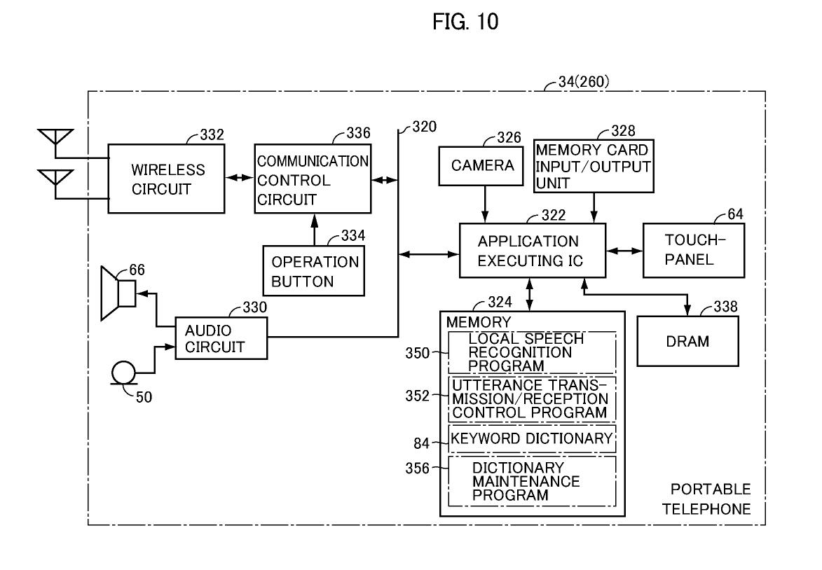

FIG. 10 shows a hardware block diagram of a portable telephone realizing portable telephone 34 in accordance with the first embodiment and portable telephone 260 in accordance with the second embodiment. In the following, portable telephone 34 will be described as a representative of portable telephones 34 and 260.

Referring to FIG. 10, portable telephone 34 includes: a microphone 50 and a speaker 66; an audio circuit 330 connected to microphone 50 and speaker 66; a bus 320, connected to audio circuit 330, for transferring data and transferring control signals; a wireless circuit 332, having an antenna for wireless communication for GPS, portable telephone line and other specification and enabling various wireless communication; a communication control circuit 336, connected to bus 320, as an intermediary between wireless circuit 332 and other modules of portable telephone 34; an operation button 334, connected to communication control circuit 336, receiving an instruction input from a user to portable telephone 34 and applying an input signal to communication control circuit 336; an application executing IC (Integrated Circuit) connected to bus 320 and including a CPU (not shown), an ROM (Read Only Memory; not shown) and an RAM (Random Access Memory; not shown) for executing various applications; a camera 326, a memory card input/output unit 328, a touch-panel 64 and a DRAM (Dynamic RAM) 338, connected to application executing IC 322; and a non-volatile memory 324, connected to application executing IC 322, storing various applications to be executed by application executing IC 322.

Non-volatile memory 324 stores: a local speech recognition processing program 350 realizing speech recognition processing unit 80 show in FIG. 1; an utterance transmission/reception control program 352 realizing determining unit 82, communication control unit 86 and execution control unit 90; and a dictionary maintenance program 356 for maintaining keywords stored in keyword dictionary 84. When any of these programs is to be executed by application executing IC 322, the program is loaded to a memory, not shown, in application executing IC 322, read from an address designated by a register referred to as a program counter of the CPU in application executing IC 322, and executed by the CPU. The result of execution is stored at an address designated by the program, of DRAM 338, a memory card mounted on memory card input/output unit 328, a memory in application executing IC 322, a memory in communication control circuit 336 or a memory in audio circuit 330.

Framing unit 52 shown in FIGS. 2 and 7 is realized by audio circuit 330. Buffer 54 and reception data buffer 272 are realized by DRAM 338, or a memory in application executing IC 322 or communication control circuit 336. Transmission/reception unit 56 is realized by wireless circuit 332 and communication control circuit 336. Control unit 58 and application executing unit 62 of FIG. 1 as well as control unit 270 and application executing unit 274 of FIG. 7 are realized, in accordance with the embodiments, by application executing IC 322.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention is inapplicable to a speech recognition client apparatus having a function of recognizing speech through communication with a speech recognition server.

### REFERENCE SIGNS LIST

30 speech recognition system

34 portable telephone

36 speech recognition server

50 microphone

54 buffer

56 transmission/reception unit

58 control unit

60 reception data buffer

62 application executing unit

80 speech recognition processing unit

82 determining unit

84 keyword dictionary

86 communication control unit

88 temporary storage unit

90 execution control unit

1. A speech recognition client apparatus receiving, through a communication with a speech recognition server, a result of speech recognition by the speech recognition server, comprising:
speech converting means for converting a speech to audio data;
speech recognizing means for performing speech recognition on said audio data;
transmission/reception means for transmitting said audio data to said speech recognition server and receiving a result of speech recognition by the speech recognition server; and
transmission/reception control means for controlling transmission of audio data by said transmission/reception means in accordance with a result of recognition of said audio data by said speech recognizing means.

2. The speech recognition client apparatus according to claim 1 wherein
said transmission/reception control means includes
keyword detecting means for detecting existence of a keyword in a result of speech recognition by said speech recognizing means and for outputting a detection signal, and
transmission start control means, responsive to said detection signal, for controlling said transmission/reception means such that of said audio data, a portion having a prescribed relation with a start of an utterance segment of said keyword is transmitted to said speech recognition server.

3. The speech recognition client apparatus according to claim 2, wherein said transmission start control means includes means responsive to said detection signal for controlling said transmission/reception means such that of said audio data, a portion starting from an utterance end position of said keyword is transmitted to said speech recognition server.

4. The speech recognition client apparatus according to claim 2, wherein said transmission start control means includes means responsive to said detection signal for controlling said transmission/reception means such that of said audio data, a portion starting from an utterance start position of said keyword is transmitted.

5. The speech recognition client apparatus according to claim 4, further comprising:
match determining means for determining whether or not a start portion of a result of speech recognition by said speech recognition server received by said transmission/reception means matches the keyword detected by said keyword detection means; and
means for selectively executing a process of using the result of speech recognition by said speech recognition server received by said transmission/reception means or a process of discarding the result of speech recognition by said speech recognition server, depending on a result of determination by said match determining means.

6. The speech recognition client apparatus according to claim 1, wherein
said transmission/reception control means includes
keyword detecting means for detecting existence of a first keyword or existence of a second keyword in a result of speech recognition by said speech recognizing means and for outputting a first detection signal or a second detection signal, respectively, the second keyword representing a request for a certain process,
transmission start control means, responsive to said first detection signal, for controlling said transmission/reception means such that a portion of the audio data having a prescribed relation with a start of an utterance segment of said first keyword is transmitted to said speech recognition server, and
transmission end control means, responsive to generation of said second detection signal after transmission of said audio signal is started by said transmission/reception means, for ending transmission of audio data by said transmission/reception means at an end position of utterance of said second keyword in said audio data.
